(19) United States
(12) Patent Application Publication
(10) Pub. No.: US 2005/0199114 A1
(43) Pub. Date: Sep. 15, 2005

(54) Cutting apparatus with alignment marker

(76) Inventor: Tzu-Feng Tseng, Taipei (TW)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 11/074,936

(22) Filed: Mar. 8, 2005

(30) Foreign Application Priority Data
Mar. 11, 2004 (TW) 093106536

(51) Int. Cl. B26D 7/06

(52) U.S. Cl. 83/522.11

(57) ABSTRACT

A cutting apparatus provides a visible mark to previously show the position of the cutting line. The cutting apparatus includes a cutting platform for placing thereon an object to be cut; a cutting tool coupled to the cutting platform for cutting the object on the platform along the cutting line; and an alignment marker coupled to the cutting platform for showing the cutting line with the visible mark.

### FIELD OF THE INVENTION

The present invention relates to a cutting apparatus, and more particularly to a cutting apparatus with an alignment marker for precise cut.

### BACKGROUND OF THE INVENTION

When a cutting operation of paper is performed with a cutting apparatus, it is general to align an edge of the paper with a scaler or ruler marked on the platform of the cutting apparatus. With the graduation of the scaler or ruler, the paper can be precisely cut in desired size. By exposing the cutting line of the paper under the cutting blade, the cutting operation can be performed afterwards. Referring to FIG. 1A, a typical cutting apparatus 10 is schematically shown, which includes a cutting platform 11 marked with a scaler or ruler 111 and a cutting tool 12. The cutting tool 12 is first pivoted up. After the paper to be cut is positioned on the platform 11, the cutting tool 12 is put down to accomplish the cutting operation.

For cutting paper into a small size or rectangular or square small pieces, it is feasible to perform precise cut with the checked platform. However, if a shape other than rectangular or square is to be created, it is difficult to result in precise cut with the conventional cutting apparatus with only scaler or ruler. For example, as shown in FIG. 1B, no reference graduation can be referred to if the paper 13 is to be cut slantingly, e.g. along the dashed line 131. Therefore, whether the shape and size of the cut paper 13 will be correct or not cannot be known before the cutting operation is performed.

### SUMMARY OF THE INVENTION

Therefore, the present invention provides a cutting apparatus that has an alignment marker so that the resulting shape and size after cutting can be estimated in advance.

The present invention provides a cutting apparatus, which comprises a cutting platform for placing thereon an object to be cut; a cutting tool coupled to the cutting platform for cutting the object on the platform along a cutting line; and an alignment marker coupled to the cutting platform for showing the cutting line with a visible mark.

In an embodiment, the visible mark is a laser beam. The alignment marker comprises a laser generator for generating a source laser; and a light refractor for receiving and refracting the source laser, oriented specifically to have the refracted source laser project on the cutting line of the object.

For example, the light refractor can be a cylindrical lens that is capable of processing a point light into a linear light.

The alignment marker further comprises a power supply for providing the laser generator with power required for generating the source laser.

Preferably, the alignment marker further comprises a power-saving controller coupled to the power supply and the laser generator for optionally interrupting power transmission from the power supply to the laser generator.

In an embodiment, the power-saving controller interrupts the power transmission from the power supply to the laser generator in response to a manual operation, for example, via a button switch.

In an embodiment, the power-saving controller interrupts the power transmission from the power supply to the laser generator when the cutting tool is in a standby position and restores the power transmission when the cutting tool is in an operational position.

In an embodiment, the power-saving controller is a micro-switch that connects to permit the power transmission when the cutting tool is raised for working and disconnects to interrupt the power transmission after the cutting tool is put down to accomplish cutting.

In an embodiment, the cutting tool comprises a cutting blade for cutting the object; a shaft coupled to the cutting platform and pivotal for rendering the cutting blade between the standby position and the operational position; and a housing for accommodating therein the shaft and attaching thereto the cutting blade. In this embodiment, the micro-switch can be disposed in the housing of the cutting tool and adjacent to the shaft. The cutting tool has a protrusion arranged on the shaft. The protrusion presses the micro-switch to make connection when the cutting tool is pivoted up with the shaft and releases the micro-switch to make disconnection when the cutting tool is pivoted down with the shaft.

The cutting apparatus according to the present invention is suitable for cutting paper.

### BRIEF DESCRIPTION OF THE DRAWINGS

The present invention may best be understood through the following description with reference to the accompanying drawings, in which:

FIG. 1A is a schematic diagram showing a conventional cutting apparatus;

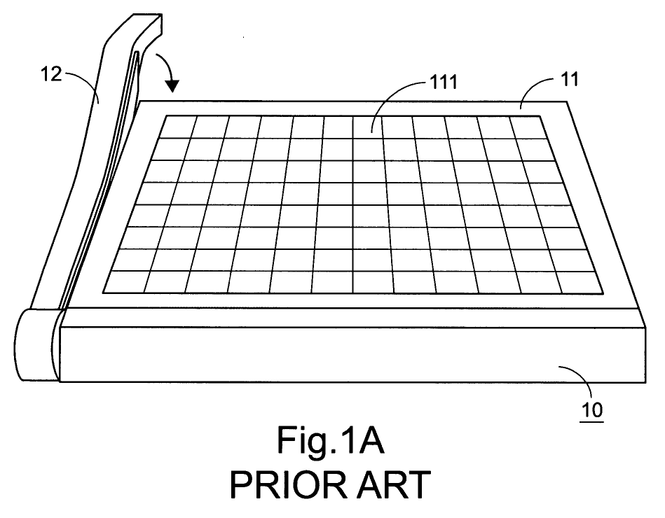

FIG. 1B is a schematic diagram showing a sheet of paper to be cut slantingly;

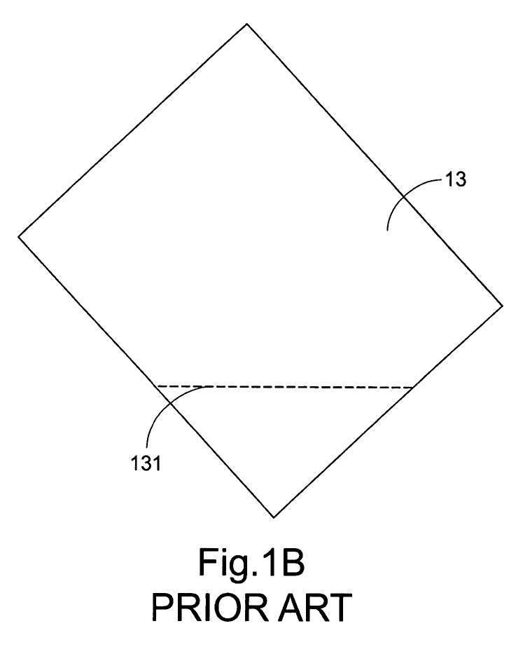

FIG. 2A is a schematic diagram showing an embodiment of a cutting apparatus according to the present invention;

FIG. 2B is a side view of cutting apparatus of FIG. 2A with the cutting tool pivoted up to a ready-to-cut position;

FIG. 2C is a partial view of the cutting apparatus of FIG. 2A with the cutting tool pivoted up to a ready-to-cut position, which schematically illustrates the work of the alignment marker;

FIG. 3 is a functional block diagram of an embodiment of an alignment marker according to the present invention;

FIG. 4 is a schematic diagram showing another embodiment of a cutting apparatus according to the present invention that includes a switch for switching on/off the alignment marker; and

FIG. 5 is a schematic diagram showing a micro-switch used in a further embodiment of a cutting apparatus according to the present invention for switching on/off the alignment marker.

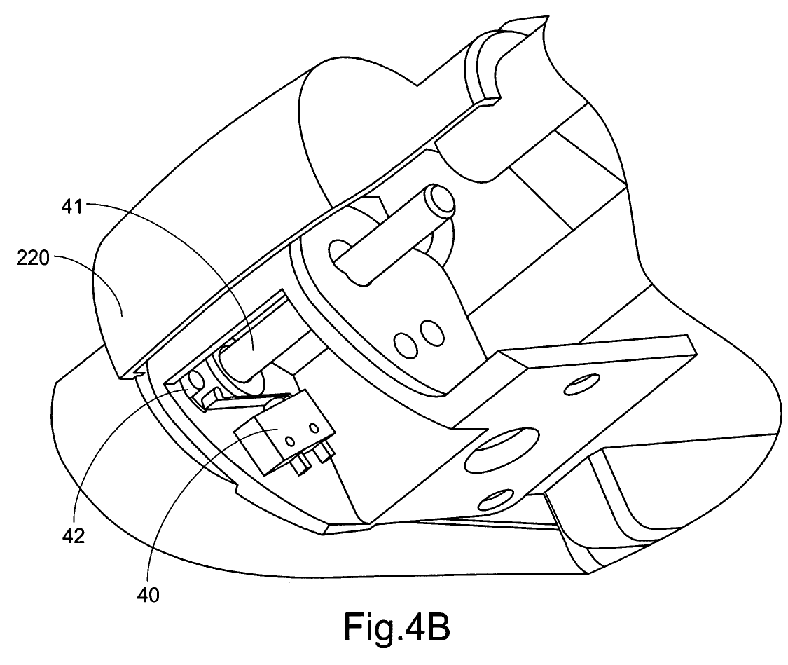

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

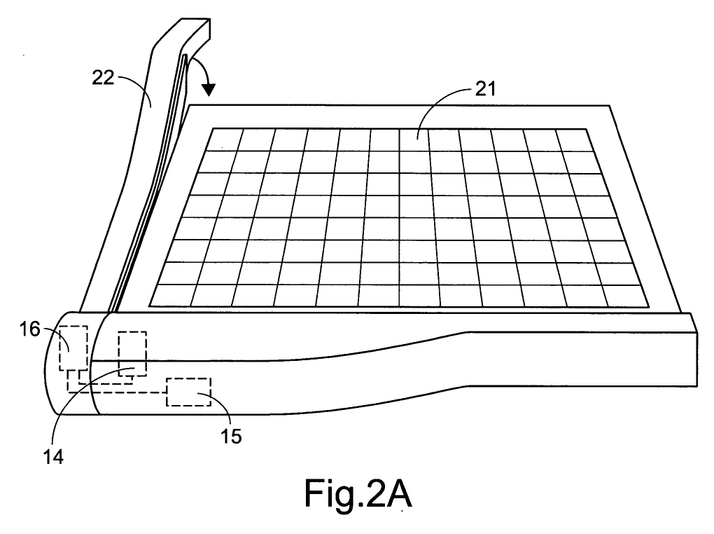

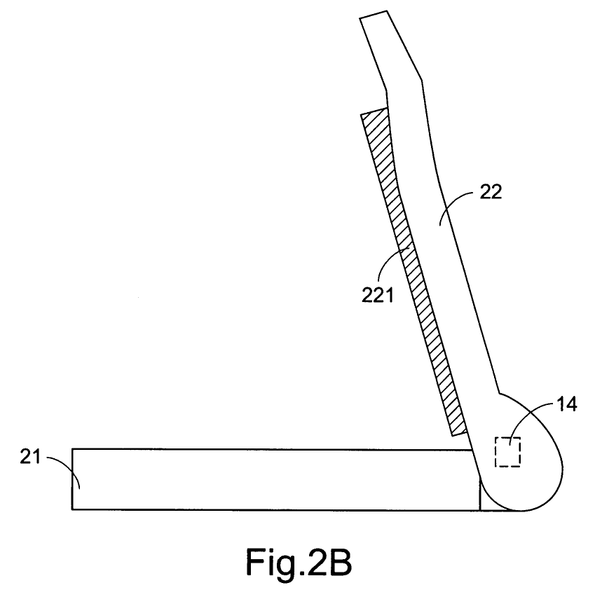

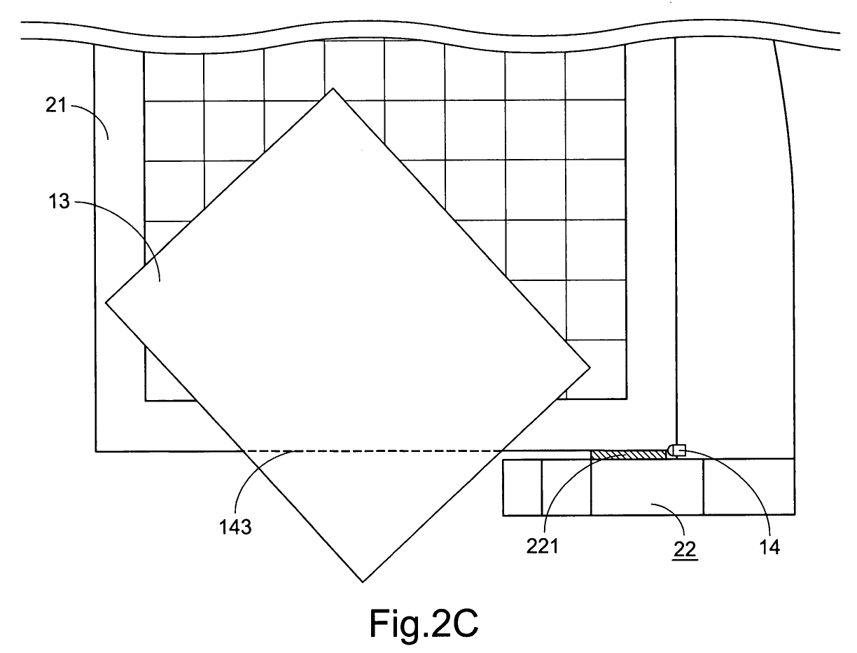

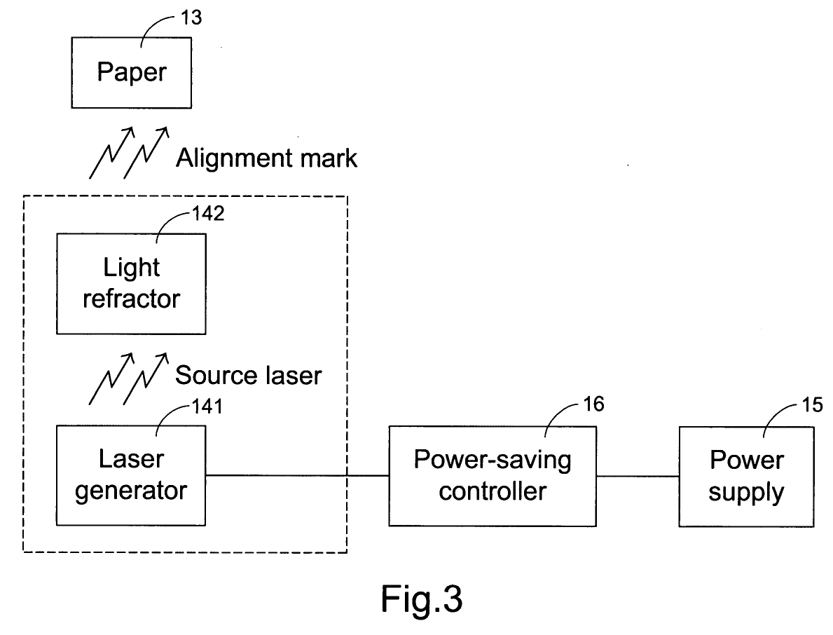

In order to facilitate cutting operations and make the user understand what the resulting object will be like after cutting, an alignment marker is provided according to the present invention. Please refer to FIG. 2A in which an embodiment of the cutting apparatus according to the present invention is illustrated. The cutting apparatus includes a cutting platform 21, a cutting tool 22, an alignment marker 14, and a power supply 15 and a power-saving controller 16 for the alignment marker 14. On the cutting platform 21, checked surface is preferably provided for normal cutting reference. The cutting tool 22 is connected to the cutting platform 21 and can be pivoted up to an operational position (the configuration shown in FIG. 2B or 2C) or down to a standby position (the configuration shown in FIG. 2A). The alignment marker 14, power supply 15 and power-saving controller 16 are mounted to the cutting platform 21 and adjacent to the cutting tool 22 for indicating where the cutting line will be. With the preview of the cutting line, the cutting operation can be performed precisely. Hereinafter, how the alignment marker 14 works is illustrated with reference to FIGS. 2B, 2C and 3.

The alignment marker 14 includes a laser generator 141 and a light refractor 142. When the cutting tool 22 is pivoted up to the operational position and the paper 13 to be cut is well positioned on the cutting platform 21, the laser generator 141 receives power from the power supply 15 and emits source laser. The source laser is processed into a laser beam via the light refractor 142, which can be a cylindrical lens, and projects onto the paper 13 as a visible mark 143 to show the cutting line. It is understood that the orientation of the light refractor 142 should be well tuned in advance so as to have the laser beam aligned with the cutting line 143. Further, for saving power, the power-saving controller 16 optionally interrupts the power transmission from the power supply 15 to the laser generator 141. When the cutting tool is in the standby position, i.e. no cutting operation is being performed, the power-saving controller 16 interrupts the power transmission so as to save power. On the other hand, the power-saving controller 16 restores the power transmission when the cutting tool 22 is in the operational position.

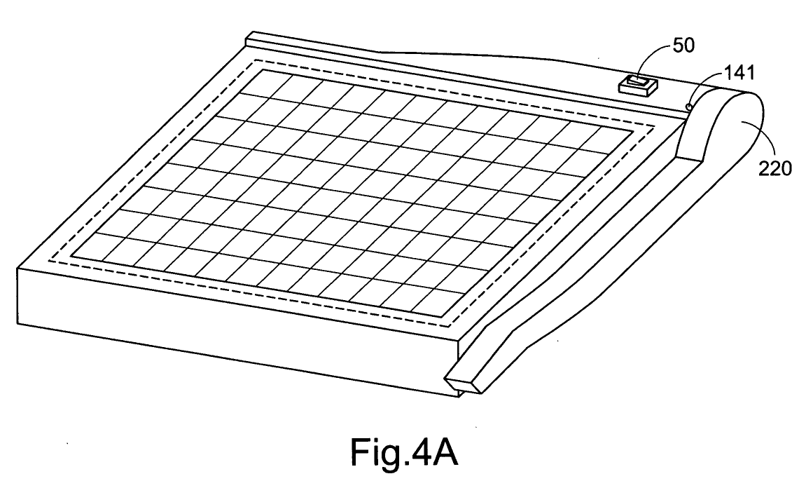

The power-saving controller 16, for example, can be a button switch 50 as shown in FIG. 4A, which is switched on or off in response to a manual operation to conduct or interrupt the power transmission. Alternatively, the power-saving controller 16 can be a micro-switch 40 as shown in FIG. 4B. The micro-switch 40 is mounted in the housing 220 of the cutting tool 22 near the shaft 41. When the cutting tool 22 is pivoted up to have the cutting blade 221 ready to cut, a protrusion 42 disposed on the outer surface of the shaft 41 rotates with the shaft 41 and thus presses on the micro-switch 40. Meanwhile, the power transmission path between the power supply 15 and the alignment marker 14 is conducted. On the other hand, while the cutting tool 22 is pivoted down to complete the cutting operation, the protrusion 42 rotates with the shaft 41 and thus releases the micro-switch 40 so that the power transmission path between the power supply 15 and the alignment marker 14 is interrupted.

According to the present invention, a visible mark is used to previously show the position of the cutting line, so the user can make proper adjustment before the real cutting operation. Therefore, waste of material and cost can be avoided.

While the invention has been described in terms of what are presently considered to be the most practical and preferred embodiment, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and structures.

1. A cutting apparatus, comprising:
a cutting platform for placing thereon an object to be cut;
a cutting tool coupled to the cutting platform for cutting said object on said platform along a cutting line; and
an alignment marker coupled to said cutting platform for showing said cutting line with a visible mark.

2. The cutting apparatus according to claim 1 wherein said visible mark is a laser beam.

3. The cutting apparatus according to claim 1 wherein said alignment marker comprises:
a laser generator for generating a source laser; and
a light refractor for receiving and refracting said source laser, oriented specifically to have said refracted source laser project on said cutting line of said object.

4. The cutting apparatus according to claim 3 wherein said light refractor is a cylindrical lens.

5. The cutting apparatus according to claim 3 wherein said alignment marker further comprises a power supply for providing said laser generator with power required for generating said source laser.

6. The cutting apparatus according to claim 5 wherein said alignment marker further comprises a power-saving controller coupled to said power supply and said laser generator for optionally interrupting power transmission from said power supply to said laser generator.

7. The cutting apparatus according to claim 6 wherein said power-saving controller interrupts said power transmission from said power supply to said laser generator in response to a manual operation.

8. The cutting apparatus according to claim 7 wherein said power-saving controller is a button switch.

9. The cutting apparatus according to claim 6 wherein said power-saving controller interrupts said power transmission from said power supply to said laser generator when said cutting tool is in a standby position and restores said power transmission when said cutting tool is in an operational position.

10. The cutting apparatus according to claim 9 wherein said power-saving controller is a micro-switch that connects to permit said power transmission when said cutting tool is raised for working and disconnects to interrupt said power transmission after said cutting tool is put down to accomplish cutting.

11. The cutting apparatus according to claim 10 wherein said cutting tool comprises:
a cutting blade for cutting said object;
a shaft coupled to said cutting platform and pivotal for rendering said cutting blade between said standby position and said operational position; and
a housing for accommodating therein said shaft and attaching thereto said cutting blade.

12. The cutting apparatus according to claim 11 wherein said micro-switch is disposed in said housing of said cutting tool and adjacent to said shaft, and said cutting tool has a protrusion arranged on said shaft, and wherein said protrusion presses said micro-switch to make connection when said cutting tool is pivoted up with said shaft and releases said micro-switch to make disconnection when said cutting tool is pivoted down with said shaft.

13. The cutting apparatus according to claim 1 for cutting paper.
